(19) United States
(12) Patent Application Publication
(10) Pub. No.: US 2024/0272408 A1
(43) Pub. Date: Aug. 15, 2024

(54) IMAGING LENS

(71) Applicant: Young Optics Inc., Hsinchu Science Park (TW)

(72) Inventors: Tsung-Pei HSIEH, Hsinchu Science Park (TW); CHING-SHENG CHANG, Hsinchu Science Park (TW); CHIEN-HSIUNG TSENG, Hsinchu Science Park (TW); HONG-HSUAN SHIAO, Hsinchu Science Park (TW)

(21) Appl. No.: 18/432,680

(22) Filed: Feb. 5, 2024

(30) Foreign Application Priority Data
Feb. 15, 2023 (TW) 112105394

(51) Int. Cl. G02B 13/00; G02B 9/60; G02B 9/62; G02B 9/64

(52) U.S. Cl. CPC G02B 13/008; G02B 9/60; G02B 9/62; G02B 13/0045; G02B 9/64

(57) ABSTRACT

An imaging lens includes a first lens, a second lens, a third lens, a fourth lens and a fifth lens with refractive powers arranged in order from an object side to an image side of the imaging lens. The first lens is closest to the object side as compared with any other lens with a refractive power in the imaging lens, and the fifth lens is closest to the image side as compared with any other lens with a refractive power in the imaging lens. The imaging lens satisfies the conditions of 0.5<D1/LT<0.8 and 0.5<DL/LT<0.8, where D1 is a lens diameter of the first lens, DL is a lens diameter of the fifth lens, and LT is a distance measured along an optical axis between an object-side surface of the first lens and an image-side surface of the fifth lens.

### CROSS-REFERENCE TO RELATED APPLICATION

This application claims the priority benefit of Taiwan application serial no. 112105394, filed Feb. 15, 2023. The entirety of the above-mentioned patent application is hereby incorporated by reference herein and made a part of this specification.

### BACKGROUND

### Field of the Invention

The invention relates to an imaging lens, and particularly to an imaging lens suitable for infrared imaging applications.

### Description of the Related Art

An infrared imaging lens is often used with in-vehicle cameras, surveillance cameras, or action cameras. For example, the infrared imaging lens is often used as an imaging lens for a laser detection/ranging system or a driver monitoring systems. In addition, lenses commonly used in consumer electronic applications may not provide reliable performance and clear vision in extreme temperature situations. Therefore, it is desirable to provide an imaging lens that has a small volume, a wide viewing angle and a wide operating temperature range and can provide good infrared imaging quality.

### BRIEF SUMMARY OF THE INVENTION

In order to achieve one or a portion of or all of the objects or other objects, one embodiment of the invention provides an imaging lens includes a first lens, a second lens, a third lens, a fourth lens and a fifth lens with refractive powers arranged in order from an object side to an image side of the imaging lens. The first lens is closest to the object side as compared with any other lens with a refractive power in the imaging lens, and the fifth lens is closest to the image side as compared with any other lens with a refractive power in the imaging lens. An aperture stop is disposed between the second lens and the fourth lens. The imaging lens is capable of giving the best imaging performance when using near-infrared light for imaging as compared with other spectral region of light. The imaging lens satisfies the conditions of 0.5<D1/LT<0.8 and 0.5<DL/LT<0.8, where D1 is a lens diameter of the first lens, DL is a lens diameter of the fifth lens, and LT is a distance measured along an optical axis between an object-side surface of the first lens and an image-side surface of the fifth lens.

Another embodiment of the invention provides an imaging lens includes a first lens, a second lens, a third lens, a fourth lens and a fifth lens with refractive powers arranged in order from an object side to an image side of the imaging lens. The first lens is closest to the object side as compared with any other lens with a refractive power in the imaging lens, and the fifth lens is closest to the image side as compared with any other lens with a refractive power in the imaging lens. An aperture stop is disposed between the second lens and the fourth lens. The imaging lens is capable of giving the best imaging performance when using near-infrared light for imaging as compared with other spectral region of light. The imaging lens satisfies the conditions of 0.5<D1/LT<0.8, 0.5<DL/LT<0.8, 3.8<D1/EFL<4.2 and 4.15<DL/EFL<4.55, where D1 is a lens diameter of the first lens, DL is a lens diameter of the fifth lens, LT is a distance measured along an optical axis between an object-side surface of the first lens and an image-side surface of the fifth lens, and EFL is an effective focal length of the imaging lens.

Through the designs of various embodiments of the invention, an infrared imaging lens can be provided with at least one of the advantages of wide viewing angles, large effective apertures, low thermal drift, wide working temperature ranges, and high-resolution imaging qualities.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a cross-sectional illustration of an imaging lens according to a first embodiment of the invention.

FIG. 2A, FIG. 2B and FIG. 2C respectively show longitudinal spherical aberration, field curvature and distortion aberration curves of the imaging lens shown in FIG. 1.

FIG. 3 shows a cross-sectional illustration of an imaging lens according to a second embodiment of the invention.

FIG. 4A, FIG. 4B and FIG. 4C respectively show longitudinal spherical aberration, field curvature and distortion aberration curves of the imaging lens shown in FIG. 3.

FIG. 5 shows a cross-sectional illustration of an imaging lens according to a third embodiment of the invention.

FIG. 6A, FIG. 6B and FIG. 6C respectively show longitudinal spherical aberration, field curvature and distortion aberration curves of the imaging lens shown in FIG. 5.

FIG. 7 shows a cross-sectional illustration of an imaging lens according to a fourth embodiment of the invention.

FIG. 8A, FIG. 8B and FIG. 8C respectively show longitudinal spherical aberration, field curvature and distortion aberration curves of the imaging lens shown in FIG. 7.

FIG. 9 shows a cross-sectional illustration of an imaging lens according to a fifth embodiment of the invention.

FIG. 10A, FIG. 10B and FIG. 10C respectively show longitudinal spherical aberration, field curvature and distortion aberration curves of the imaging lens shown in FIG. 9.

### DETAILED DESCRIPTION OF THE INVENTION

In the following detailed description of the preferred embodiments, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. Further, “First,” “Second,” etc., as used herein, are used as labels for nouns that they precede, and do not imply any type of ordering (e.g., spatial, temporal, logical, etc.).

The term “lens” refers to an element made from a partially or entirely light-transmissive material with optical power. The material commonly includes plastic or glass.

In an imaging system, an object side may refer to one side of an optical path of an imaging lens comparatively near a subject to be picked-up, and an image side may refer to other side of the optical path comparatively near a photosensor.

A certain region of an object side surface (or an image side surface) of a lens may be convex or concave. Herein, a convex or concave region is more outwardly convex or inwardly concave in the direction of an optical axis as compared with other neighboring regions of the object/image side surface.

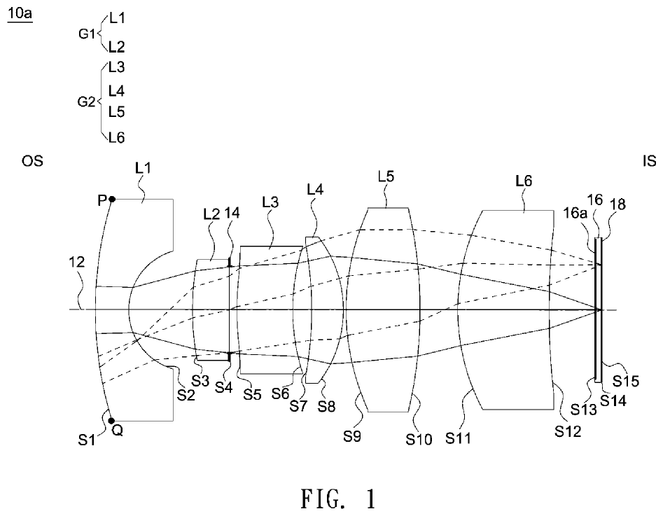

FIG. 1 shows a cross-sectional illustration of an imaging lens according to a first embodiment of the invention. Referring to FIG. 1, in this embodiment, an imaging lens 10a includes a first lens group G1, a second lens group G2, and an aperture stop 14 disposed between the first lens group G1 and the second lens group G2. The first lens group G1 has a negative refractive power and includes a lens L1 and a lens L2 arranged in order from an object side OS to an image side IS of the imaging lens 10a. The second lens group G2 has a negative refractive power and includes a lens L3, a lens L4, a lens L5 and a lens L6 arranged in order from the object side OS to the image side IS. Furthermore, a cover plate 16 and an image sensor (not shown) can be arranged on the image side IS. The cover plate 16 may be a plate made of any suitable light-transmissive material, such as glass. The cover plate 16 may function to adjust the optical path length and protect the imaging lens. An image plane (infrared focal plane) of the imaging lens 10a on the image sensor is marked as 18. Besides, in this embodiment, the cover plate 16 is disposed on one side of the second lens group G2 away from the first lens group G1. The cover plate 16 may be provided with a filter film 16a that can filter out 99% of light in the wavelength range of 360-830 nm. In other embodiment, an independent optical filter can be used instead. The aperture stop 14 is a light-blocking element that limits the amount of light passing through the imaging lens 10a. In other embodiment, the aperture stop 14 is defined by an inner diameter of a lens barrel and thus is not an independent optical element. Light from a subject to be captured may enter the imaging lens 10a and pass through the lens L1, the lens L2, the aperture stop 14, the lens 3, the lens L4, the lens L5 the lens L6 and the cover plate 16 in succession, and finally forms an image on the image plane 18.

In each of the following embodiments, the object side OS is located on the left side and the image side IS is located on the right side of each figure, and thus this is not repeatedly described in the following for brevity. In this embodiment, the lenses L1-L6 of the imaging lens 10a respectively have object-side surfaces S1, S3, S5, S7, S9 and S11 facing the object side OS and allowing light beams to pass therethrough, and the lenses L1-L6 respectively have image-side surfaces S2, S4, S6, S8, S10 and S12 facing the image side IS and allowing light beams to pass therethrough. The aperture stop 14 is disposed on the image-side surface S4 of the lens L2, and refractive powers of the lenses L1-L6 are negative, positive, negative, positive, positive and positive, respectively. In this embodiment, each of the lenses L1-L6 is a glass spherical lens, but the invention is not limited thereto.

In at least some embodiments of the invention, the imaging lens may have a quasi-telecentric configuration in image space. For example, as shown in FIG. 1, when light beams entering the imaging lens 10a approach the image plane 18, each chief ray of the light beams is substantially parallel to the optical axis 12 of the imaging lens 10a (i.e., a chief ray angle measure between the chief ray and the optical axis 12 ranges from −2 degrees to +2 degrees) on the image side IS, thereby improving the luminous uniformity for the image plane 18.

In at least some embodiments of the invention, the imaging lens gives the best imaging performance when using near-infrared light (e.g., in a wavelength range between about 780 nm and about 1300 nm) for imaging as compared with other spectral region of light. Further, among different wavelengths of near-infrared light, the imaging lens may give the best imaging performance in a wavelength range of 937-943 nm. Moreover, in the wavelength range of 937-943 nm, the imaging lens may give the best imaging performance when using a 940 nm near-infrared light for imaging.

In at least some embodiments of the invention, the first lens group G1 includes two or three lenses with refractive powers, and the second lens group G2 includes two to six lenses with refractive powers, but the number, shape and optical characteristic of lenses may vary according to actual needs. In at least some embodiments of the invention, the imaging lens has at least two lenses with a refractive index greater than 1.9. For example, each of the lens L1, the lens L2, the lens L4, the lens L5 and the lens L6 has a refractive index greater than 1.9

Each lens may be assigned a parameter of “lens diameter”. For example, as shown in FIG. 1, the lens L1 has an object-side surface S1 and an image-side surface S2, each lens surface defines two outermost edge turning points P and Q at opposite ends of the optical axis 12, and a maximum distance between the two edge turning points P and Q in the direction perpendicular to the optical axis 12 is referred to as a lens diameter. In other words, the lens diameter can be an outside diameter of a lens. In at least some embodiment, the imaging lens may satisfy conditions of 0.5<D1/LT<0.8 and 0.5<DL/LT<0.8, where D1 is a lens diameter of the lens (such as the lens L1) closest to the object side OS, DL is a lens diameter of the lens (such as the lens L6) closest to the image side IS, and LT is a total lens length that is a distance measured along the optical axis 12 between the object-side surface of the lens closest to the object side OS (such as the surface S1 of the lens L1) and the image-side surface of the lens closest to the image side IS (such as the surface S12 of the lens L6). Meeting the condition of 0.5<D1/LT<0.8 may facilitate light converging capability of lenses to allow for better optical performance in a limited space. Besides, meeting the condition of 0.5<DL/LT<0.8 means that a ratio of a lens diameter of the lens closest to the image side to the total lens length is relatively large, which may enhance light collection to facilitate a quasi-telecentric configuration. In the embodiment of the imaging lens 10a, D1/LT=0.62 and DL/LT=0.67.

In at least some embodiment, the imaging lens may satisfy conditions of 3.8<D1/EFL<4.2 and 4.15<DL/EFL<4.55, where D1 is a lens diameter of the lens (such as the lens L1) closest to the object side OS, DL is a lens diameter of the lens (such as the lens L6) closest to the image side IS, and EFL is an effective focal length of the imaging lens. Meeting the above conditions may achieve a balance between miniaturization and optical performance, and allow the imaging lens to have better performance when using near-infrared light for imaging. In the embodiment of the imaging lens 10a, D1/EFL=4.00 and DL/EFL=4.35.

A diagonal field of view (DFOV) refers to a light collection angle of the optical surface closest to the object side; that is, the DFOV is a full field of view measured diagonally. In at least some embodiments, the DFOV may range from 150 to 170 degrees. In this embodiment, the DFOV of the imaging lens 10a is 160 degrees.

In this embodiment, the imaging lens 10a includes six lenses with refractive powers. In this embodiment, an effective focal length (EFL) is 6.9 mm, an F-number (F #) is 1.3, a maximum image height is 7.95 mm, a lens diameter D1 of the lens closest to the object side OS is 27.6 mm, a lens diameter DL of the lens closest to the image side IS is 30.0 mm, and a total lens length LT is 44.57 mm.

Detailed optical data and design parameters of the optical lens 10a are shown in Table 1 below. Note the data provided below are not used for limiting the invention, and those skilled in the art may suitably modify parameters or settings of the following embodiment with reference of the invention without departing from the scope or spirit of the invention.

Table 1 lists the values of parameters for each lens of an imaging system. Besides, the radius of curvature and interval shown in Table 1 are all in a unit of mm. The field heading “radius of curvature” shown in Table 1 is a reciprocal of the curvature. When a lens surface has a positive radius of curvature, the center of the lens surface is located towards the image side. When a lens surface has a negative radius of curvature, the center of the lens surface is located towards the object side. The field heading “interval” represents a distance between two adjacent surfaces along the optical axis 12 of the imaging lens 10a. For example, an interval of the surface S1 is a distance between the surface S1 and the surface S2 along the optical axis 12, an interval of the surface S2 is a distance between the surface S2 and the surface S3 along the optical axis 12. Further, the interval, refractive index and Abbe number of any lens listed in the column of “Object description” show values in a horizontal row aligned with the position of that lens, so that related descriptions are omitted for sake of brevity.

TABLE 1

| | | Radius of | Interval | Refractive | Abbe |
|---|---|---|---|---|---|
| Object description | Surface | curvature(mm) | (mm) | index (nd) | number (Vd) |
| Lens L1(meniscus) | S1 | 45.074 | 3.266 | 1.904 | 31 |
| | S2 | 7.129 | 6.356 | | |
| Lens L2 | S3 | 33.354 | 3.591 | 1.946 | 18 |
| (plano-convex) | | | | | |
| Aperture stop 14 | S4 | Infinity | 0.725 | | |
| Lens L3(meniscus) | S5 | 46.111 | 5.534 | 1.808 | 22 |
| | S6 | 26.82 | 1.842 | | |
| Lens L4(meniscus) | S7 | −47.124 | 3.187 | 1.946 | 18 |
| | S8 | −14.814 | 0.2 | | |
| Lens L5(bi-convex) | S9 | 30.43 | 7.262 | 1.904 | 31 |
| | S10 | −61.041 | 3.86 | | |
| Lens L6(meniscus) | S11 | 27.421 | 8.876 | 1.904 | 31 |
| | S12 | 102.809 | 4.693 | | |
| Cover plate 16 | S13 | Infinity | 0.5 | 1.904 | 31 |
| | S14 | Infinity | 0.04 | | |
| Image plane | S15 | Infinity | 0 | | |

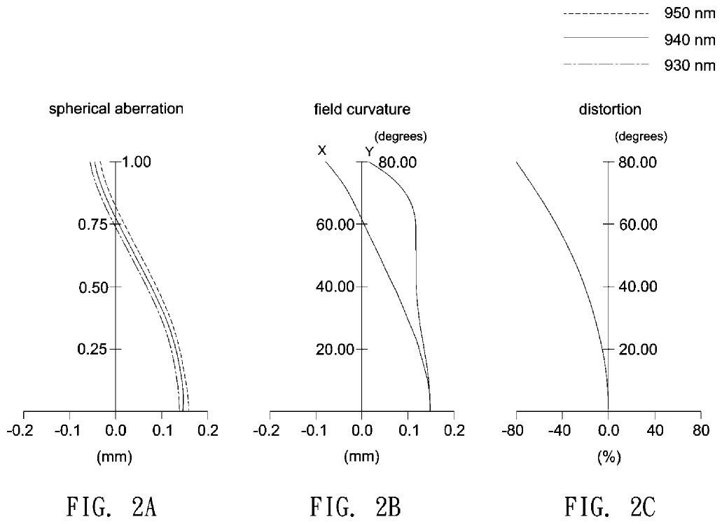

FIG. 2A, FIG. 2B and FIG. 2C respectively show longitudinal spherical aberration, field curvature and distortion aberration curves of the imaging lens 10a measured at wavelengths of 930 nm, 940 nm and 950 nm. Because the graphs shown in FIG. 2A, FIG. 2B and FIG. 2C are all within the standard range, it can be verified that the imaging lens 10a can achieve high-resolution near-infrared imaging effects.

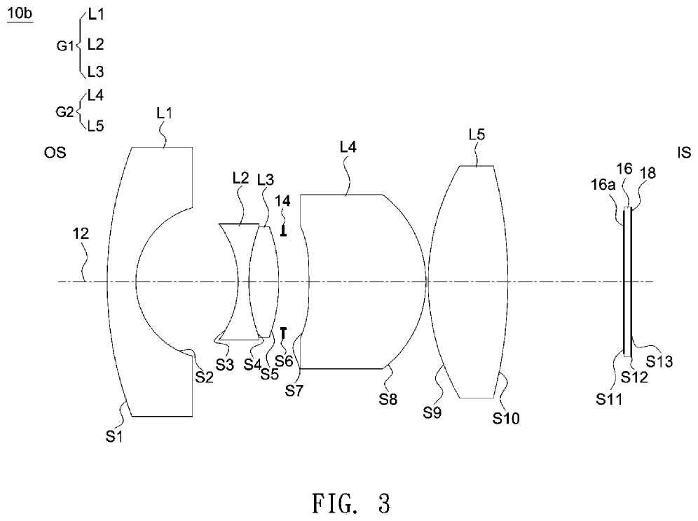

FIG. 3 shows a cross-sectional illustration of an imaging lens according to a second embodiment of the invention. In this embodiment, the imaging lens 10b includes a lens L1, a lens L2, a lens L3, a lens LA and a lens L5 with refractive powers arranged in order from the object side OS to the image side IS and includes an aperture stop 14 disposed between the lens L3 and the lens LA. The refractive powers of the lenses L1-L5 are negative, negative, positive, positive and positive, respectively. In this embodiment, the lens L1, the lens L2, the lens L3 and the lens L5 are glass spherical lenses, and the lens LA is a glass aspheric lens. In this embodiment, the lens L2 and the lens L3 are paired together, such as being cemented to each other, to form a doublet lens to reduce stray light propagating in the imaging lens 10b and allow for more relaxed tolerances in manufacturing the imaging lens 10b to thus improve the yield rate.

In this embodiment, the imaging lens 10b includes five lenses with refractive powers. In this embodiment, an effective focal length (EFL) is 6.9 mm, an F-number (F #) is 1.3, a diagonal field of view (DFOV) is 160 degrees, a maximum image height is 7.95 mm, a lens diameter D1 of the lens closest to the object side OS is 31.0 mm, a lens diameter DL of the lens closest to the image side IS is 26.5 mm, a total lens length LT is 38.32 mm, D1/LT=0.81, DL/LT=0.69, D1/EFL=4.49, and DL/EFL=3.84.

Detailed optical data and design parameters of the lenses and other optical components of the imaging lens 10b are shown in Table 2.

TABLE 2

| | | Radius of | Interval | Refractive | Abbe |
|---|---|---|---|---|---|
| Object description | Surface | curvature(mm) | (mm) | index (nd) | number (Vd) |
| Lens L1(meniscus) | S1 | 44.964 | 2.8 | 1.743 | 49 |
| | S2 | 8.65 | 9.758 | | |
| Lens L2 | S3 | −11.077 | 1 | 1.487 | 70 |
| (bi-concave) | | | | | |
| Lens L3(bi-convex) | S4 | 19.286 | 2.81 | 1.946 | 18 |
| | S5 | −19.286 | 0.2 | | |
| Aperture stop 14 | S6 | Infinity | 2.673 | | |
| Lens L4(aspheric) | S7* | −41.22 | 11.123 | 1.495 | 81 |
| | S8* | −12.37 | 0.2 | | |
| Lens L5(bi-convex) | S9 | 27.557 | 7.655 | 1.903 | 31 |
| | S10 | −56.279 | 11.041 | | |
| Cover plate 16 | S11 | Infinity | 0.5 | 1.517 | 64 |
| | S12 | Infinity | 0.04 | | |
| Image plane | S13 | Infinity | 0 | | |

An aspheric lens indicates at least one of its front lens surface and rear lens surface has a radius of curvature that varies along a center axis to correct abbreviations. In the following design examples of the invention, each aspheric surface satisfies the following equation:

$$Z = \frac{c {r}^{2}}{1 + \sqrt{1 - ( 1 + k ) {c}^{2} {r}^{2}}} + A {r}^{4} + B {r}^{6} + C {r}^{8} + D {r}^{10} + E {r}^{12} + F {r}^{14} + {Gr}^{16} + …$$

where Z denotes a sag of an aspheric surface along the optical axis 12, c denotes a reciprocal of a radius of an osculating sphere, K denotes a conic constant, r denotes a height of the aspheric surface measured in a direction perpendicular to the optical axis 12, and parameters A-G are 4th, 6th, 8th, 10th, 12th, 14th and 16th order aspheric coefficients.

Table 3 shows the conic constant K and aspheric coefficients A-E for each aspheric surface of the imaging lens 10b. Note the data provided below are not used for limiting the invention, and those skilled in the art may suitably modify parameters or settings of the following embodiment with reference of the invention without departing from the scope or spirit of the invention.

TABLE 3

| Surface | S7* | S8* |
|---|---|---|
| K | 0 | −0.749 |
| A | −2.08E−04 | −2.42E−05 |
| B | −8.60E−06 | −4.82E−07 |
| C | 4.59E−07 | 7.52E−09 |
| D | −1.35E−08 | −1.17E−10 |
| E | 1.52E−10 | 7.17E−13 |

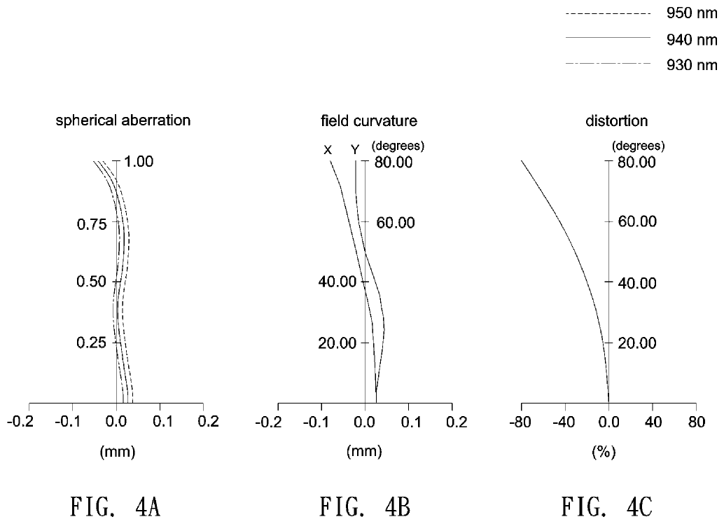

FIG. 4A, FIG. 4B and FIG. 4C respectively show longitudinal spherical aberration, field curvature and distortion aberration curves of the imaging lens 10b measured at wavelengths of 930 nm, 940 nm and 950 nm. Because the graphs shown in FIG. 4A, FIG. 4B and FIG. 4C are all within the standard range, it can be verified that the imaging lens 10b can achieve high-resolution near-infrared imaging effects.

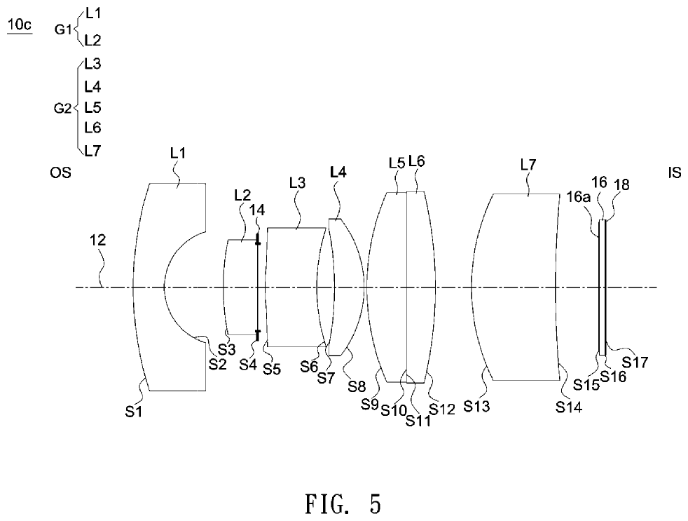

FIG. 5 shows a cross-sectional illustration of an imaging lens according to a third embodiment of the invention. In this embodiment, the imaging lens 10c includes a lens L1, a lens L2, a lens L3, a lens LA, a lens L5, a lens L6 and a lens L7 with refractive powers arranged in order from the object side OS to the image side IS and includes an aperture stop 14 disposed on an image-side surface S4 of the lens L2. The refractive powers of the lenses L1-L7 are negative, positive, negative, positive, positive, positive and positive, respectively. In this embodiment, the lenses L1-L7 are all glass spherical lenses.

In this embodiment, the imaging lens 10c includes seven lenses with refractive powers. In this embodiment, an effective focal length (EFL) is 6.9 mm, an F-number (F #) is 1.3, a diagonal field of view (DFOV) is 160 degrees, a maximum image height is 7.95 mm, a lens diameter D1 of the lens closest to the object side OS is 27.6 mm, a lens diameter DL of the lens closest to the image side IS is 30.0 mm, a total lens length LT is 44.58 mm, D1/LT=0.62, DL/LT=0.67, D1/EFL=4.00, and DL/EFL=4.35.

Detailed optical data and design parameters of the lenses and other optical components of the imaging lens 10c are shown in Table 4.

TABLE 4

| | | Radius of | Interval | Refractive | Abbe |
|---|---|---|---|---|---|
| Object description | Surface | curvature(mm) | (mm) | index (nd) | number (Vd) |
| Lens L1(meniscus) | S1 | 45.074 | 3.266 | 1.904 | 31 |
| | S2 | 7.129 | 6.356 | | |
| Lens L2 | S3 | 33.354 | 3.591 | 1.946 | 18 |
| (plano-convex) | | | | | |
| Aperture stop 14 | S4 | Infinity | 0.725 | | |
| Lens L3(meniscus) | S5 | 46.111 | 5.534 | 1.808 | 22 |
| | S6 | 26.82 | 1.842 | | |
| Lens L4(meniscus) | S7 | −47.124 | 3.187 | 1.946 | 18 |
| | S8 | −14.814 | 0.2 | | |
| Lens L5 | S9 | 30.43 | 4.262 | 1.904 | 31 |
| (plano-convex) | | | | | |
| | S10 | Infinity | 0.01 | | |
| Lens L6 | S11 | Infinity | 3 | 1.904 | 31 |
| (plano-convex) | | | | | |
| | S12 | −61.041 | 3.86 | | |
| Lens L7(meniscus) | S13 | 27.421 | 8.876 | 1.904 | 31 |
| | S14 | 102.8 | 4.68 | | |
| Cover plate 16 | S15 | Infinity | 0.5 | 1.517 | 64 |
| | S16 | Infinity | 0.04 | | |
| Image plane | S17 | Infinity | 0 | | |

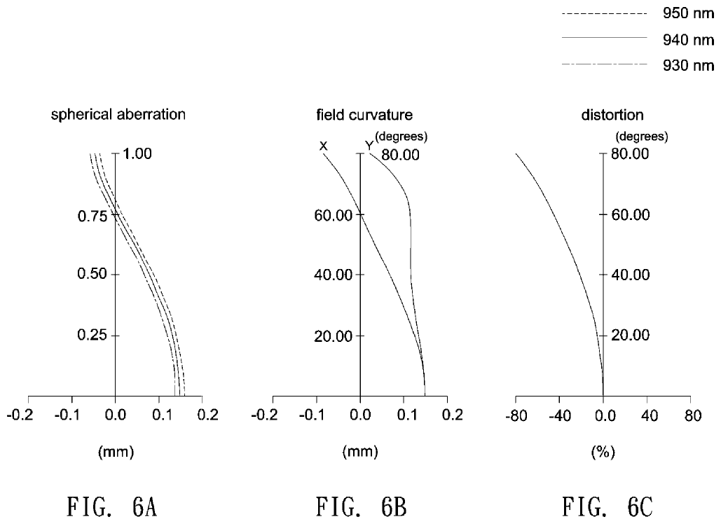

FIG. 6A, FIG. 6B and FIG. 6C respectively show longitudinal spherical aberration, field curvature and distortion aberration curves of the imaging lens 10c measured at wavelengths of 930 nm, 940 nm and 950 nm. Because the graphs shown in FIG. 6A, FIG. 6B and FIG. 6C are all within the standard range, it can be verified that the imaging lens 10c can achieve high-resolution near-infrared imaging effects.

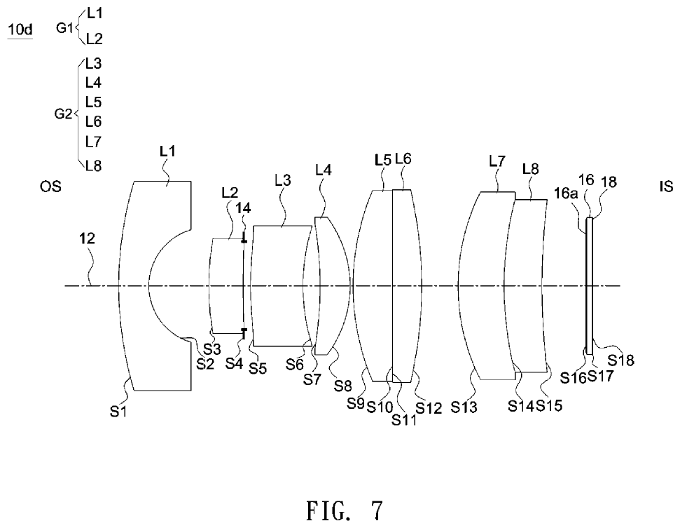

FIG. 7 shows a cross-sectional illustration of an imaging lens according to a fourth embodiment of the invention. In this embodiment, the imaging lens 10d includes a lens L1, a lens L2, a lens L3, a lens LA, a lens L5, a lens L6, a lens L7 and a lens L8 with refractive powers arranged in order from the object side OS to the image side IS and includes an aperture stop 14 disposed on an image-side surface S4 of the lens L2. The refractive powers of the lenses L1-L8 are negative, positive, negative, positive, positive, positive, positive and positive, respectively. In this embodiment, the lenses L1-L8 are all glass spherical lenses, and the lens L7 and the lens L8 are, for example, cemented to form a doublet lens to reduce stray light propagating in the imaging lens 10d and allow for more relaxed tolerances in manufacturing the imaging lens 10d to thus improve the yield rate.

In this embodiment, the imaging lens 10d includes eight lenses with refractive powers. In this embodiment, an effective focal length (EFL) is 6.9 mm, an F-number (F #) is 1.3, a diagonal field of view (DFOV) is 160 degrees, a maximum image height is 7.95 mm, a lens diameter D1 of the lens closest to the object side OS is 27.6 mm, a lens diameter DL of the lens closest to the image side IS is 29.5 mm, a total lens length LT is 44.58 mm, D1/LT=0.62, DL/LT=0.66, D1/EFL=4.00, and DL/EFL=4.28.

Detailed optical data and design parameters of the lenses and other optical components of the imaging lens 10d are shown in Table 5.

TABLE 5

| | | Radius of | Interval | Refractive | Abbe |
|---|---|---|---|---|---|
| Object description | Surface | curvature(mm) | (mm) | index (nd) | number (Vd) |
| Lens L1(meniscus) | S1 | 45.074 | 3.266 | 1.904 | 31 |
| | S2 | 7.129 | 6.356 | | |
| Lens L2 | S3 | 33.354 | 3.591 | 1.946 | 18 |
| (plano-convex) | | | | | |
| Aperture stop 14 | S4 | Infinity | 0.725 | | |
| Lens L3(meniscus) | S5 | 46.111 | 5.534 | 1.808 | 22 |
| | S6 | 26.82 | 1.842 | | |
| Lens L4(meniscus) | S7 | −47.124 | 3.187 | 1.946 | 18 |
| | S8 | −14.814 | 0.2 | | |
| Lens L5 | S9 | 30.43 | 4.262 | 1.904 | 31 |
| (plano-convex) | | | | | |
| | S10 | Infinity | 0.01 | | |
| Lens L6 | S11 | Infinity | 3 | 1.904 | 31 |
| (plano-convex) | | | | | |
| | S12 | −61.041 | 3.86 | | |
| Lens L7(meniscus) | S13 | 27.421 | 4.876 | 1.904 | 31 |
| Lens L8(meniscus) | S14 | 50 | 4 | 1.904 | 31 |
| | S15 | 102.809 | 4.683 | | |
| Cover plate 16 | S16 | Infinity | 0.5 | 1.517 | 64 |
| | S17 | Infinity | 0.04 | | |
| Image plane | S18 | Infinity | 0 | | |

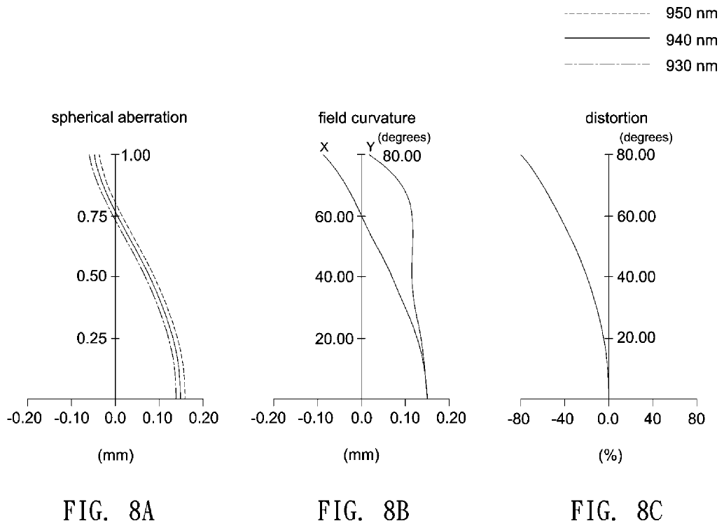

FIG. 8A, FIG. 8B and FIG. 8C respectively show longitudinal spherical aberration, field curvature and distortion aberration curves of the imaging lens 10d measured at wavelengths of 930 nm, 940 nm and 950 nm. Because the graphs shown in FIG. 8A, FIG. 8B and FIG. 8C are all within the standard range, it can be verified that the imaging lens 10d can achieve high-resolution near-infrared imaging effects.

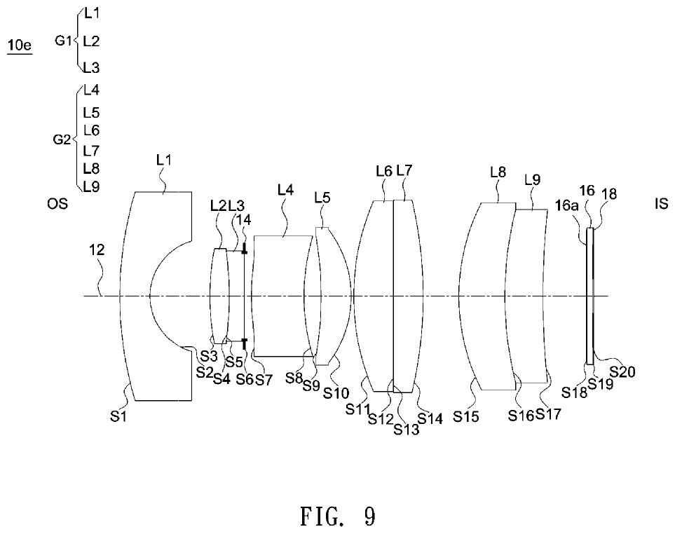

FIG. 9 shows a cross-sectional illustration of an imaging lens according to a fifth embodiment of the invention. In this embodiment, the imaging lens 10e includes a lens L1, a lens L2, a lens L3, a lens LA, a lens L5, a lens L6, a lens L7, a lens L8 and a lens L9 with refractive powers arranged in order from the object side OS to the image side IS and includes an aperture stop 14 disposed on an image-side surface S6 of the lens L3. The refractive powers of the lenses L1-L9 are negative, positive, negative, negative, positive, positive, positive, positive and positive, respectively. In this embodiment, the lenses L1-L9 are all glass spherical lenses, and the lens L8 and the lens L9 are, for example, cemented to form a doublet lens to reduce stray light propagating in the imaging lens 10e and allow for more relaxed tolerances in manufacturing the imaging lens 10e to thus improve the yield rate.

In this embodiment, the imaging lens 10e includes nine lenses with refractive powers. In this embodiment, an effective focal length (EFL) is 6.9 mm, an F-number (F #) is 1.3, a diagonal field of view (DFOV) is 160 degrees, a maximum image height is 7.95 mm, a lens diameter D1 of the lens closest to the object side OS is 27.6 mm, a lens diameter DL of the lens closest to the image side IS is 29.5 mm, a total lens length LT is 44.58 mm. D1/LT=0.62. DL/LT=0.66. D1/EFL=4.00, and DL/EFL=4.28.

Detailed optical data and design parameters of the lenses and other optical components of the imaging lens 10e are shown in Table 6.

TABLE 6

| | | Radius of | Interval | Refractive | Abbe |
|---|---|---|---|---|---|
| Object description | Surface | curvature(mm) | (mm) | index (nd) | number (Vd) |
| Lens L1(meniscus) | S1 | 45.074 | 3.266 | 1.904 | 31 |
| | S2 | 7.129 | 6.356 | | |
| Lens L2(bi-convex) | S3 | 33.354 | 1.991 | 1.946 | 18 |
| | S4 | −50 | 0.01 | | |
| Lens L3 | S5 | −50 | 1.6 | 1.946 | 18 |
| (plano-concave) | | | | | |
| Aperture stop 14 | S6 | Infinity | 0.725 | | |
| Lens L4(meniscus) | S7 | 46.111 | 5.534 | 1.946 | 18 |
| | S8 | 26.82 | 1.842 | | |
| Lens L5(meniscus) | S9 | −47.124 | 3.187 | 1.904 | 31 |
| | S10 | −14.814 | 0.2 | | |
| Lens L6 | S11 | 30.43 | 4.262 | 1.904 | 31 |
| (plano-convex) | | | | | |
| | S12 | Infinity | 0.01 | | |
| Lens L7 | S13 | Infinity | 3 | 1.904 | 31 |
| (plano-convex) | | | | | |
| | S14 | −61.041 | 3.86 | | |
| Lens L8(meniscus) | S15 | 27.421 | 4.876 | 1.904 | 31 |
| Lens L9(meniscus) | S16 | 50 | 4 | 1.904 | 31 |
| | S17 | 102.809 | 4.683 | | |
| Cover plate 16 | S18 | Infinity | 0.5 | 1.517 | 64 |
| | S19 | Infinity | 0.04 | | |
| Image plane | S20 | Infinity | 0 | | |

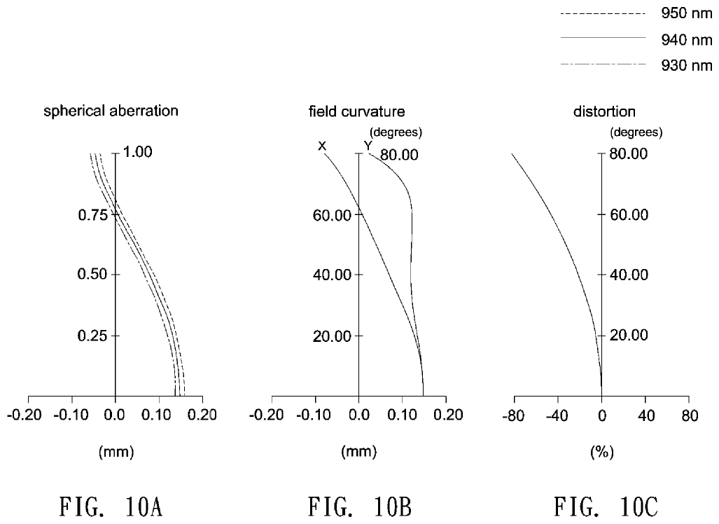

FIG. 10A, FIG. 10B and FIG. 10C respectively show longitudinal spherical aberration, field curvature and distortion aberration curves of the imaging lens 10e measured at wavelengths of 930 nm, 940 nm and 950 nm. Because the graphs shown in FIG. 10A, FIG. 10B and FIG. 10C are all within the standard range, it can be verified that the imaging lens 10e can achieve high-resolution near-infrared imaging effects.

According to the above embodiments, meeting the designed characteristics and arrangement of optical components set forth in the above may achieve good quality for near-infrared imaging and achieve a miniaturized lens assembly having a wide field of view and a large effective aperture. Further, in order to meet specific requirements for the application of in-vehicle cameras, each lens element of the imaging lens can be a glass lens to allow for a wide working temperature range and ensure stable image qualities under harsh environments with large temperature differences. In addition, in one embodiment, the imaging lens may have a quasi-telecentric configuration in image space, where a ratio of a lens diameter of the lens closest to the image side to the total lens length is relatively large to enhance light collection and thus facilitate a quasi-telecentric configuration. Through the designs of various embodiments of the invention, an infrared imaging lens can be provided with at least one of the advantages of wide viewing angles, large effective apertures, low thermal drift, wide working temperature ranges, and high-resolution imaging qualities.

Though the embodiments of the invention have been presented for purposes of illustration and description, they are not intended to be exhaustive or to limit the invention. Accordingly, many modifications and variations without departing from the spirit of the invention or essential characteristics thereof will be apparent to practitioners skilled in this art. It is intended that the scope of the invention be defined by the claims appended hereto and their equivalents in which all terms are meant in their broadest reasonable sense unless otherwise indicated.

What is claimed is:

1. An imaging lens, comprising:
a first lens, a second lens, a third lens, a fourth lens and a fifth lens with refractive powers arranged in order from an object side to an image side of the imaging lens, wherein the first lens is closest to the object side as compared with any other lens with a refractive power in the imaging lens, and the fifth lens is closest to the image side as compared with any other lens with a refractive power in the imaging lens; and
an aperture stop disposed between the second lens and the fourth lens,
wherein the imaging lens is capable of giving the best imaging performance when using near-infrared light for imaging as compared with other spectral region of light, and the imaging lens satisfies the conditions of 0.5<D1/LT<0.8 and 0.5<DL/LT<0.8, where D1 is a lens diameter of the first lens, DL is a lens diameter of the fifth lens, and LT is a distance measured along an optical axis between an object-side surface of the first lens and an image-side surface of the fifth lens.

2. The imaging lens as claimed in claim 1, wherein the second lens and the third lens are paired together to form a doublet lens.

3. The imaging lens as claimed in claim 1, wherein a chief ray angle on the image side measured between a chief ray and the optical axis of the imaging lens ranges from −2 degrees to 2 degrees.

4. The imaging lens as claimed in claim 1, wherein at least four lenses of the first lens, the second lens, the third lens, the fourth lens and the fifth lens have a refractive index greater than 1.9.

5. The imaging lens as claimed in claim 1, wherein the first lens, the second lens, the third lens, the fourth lens and the fifth lens respectively have negative, negative, positive, positive and positive refractive powers.

6. The imaging lens as claimed in claim 5, further comprising a sixth lens with a positive refractive power disposed between the first lens and the second lens.

7. The imaging lens as claimed in claim 1, wherein the fourth lens is an aspheric lens.

8. The imaging lens as claimed in claim 1, wherein each of the first lens, the second lens, the third lens, the fourth lens and the fifth lens is a glass lens.

9. The imaging lens as claimed in claim 1, wherein the imaging lens gives the best imaging performance in a wavelength range of 937-943 nm among different wavelengths of near-infrared light.

10. The imaging lens as claimed in claim 1, further comprising:
a cover plate provided with a filter film and disposed on one side of the fifth lens away from the first lens, wherein the filter film is capable of filtering out 99% of light in a wavelength range of 360-830 nm.

11. An imaging lens, comprising:
a first lens, a second lens, a third lens, a fourth lens and a fifth lens with refractive powers arranged in order from an object side to an image side of the imaging lens, wherein the first lens is closest to the object side as compared with any other lens with a refractive power in the imaging lens, and the fifth lens is closest to the image side as compared with any other lens with a refractive power in the imaging lens; and
an aperture stop disposed between the second lens and the fourth lens,
wherein the imaging lens is capable of giving the best imaging performance when using near-infrared light for imaging as compared with other spectral region of light, and the imaging lens satisfies the following conditions:
0.5<D1/LT<0.8;
0.5<DL/LT<0.8;
3.8<D1/EFL<4.2; and
4.15<DL/EFL<4.55, where D1 is a lens diameter of the first lens, DL is a lens diameter of the fifth lens, LT is a distance measured along an optical axis between an object-side surface of the first lens and an image-side surface of the fifth lens, and EFL is an effective focal length of the imaging lens.

12. The imaging lens as claimed in claim 11, wherein the second lens and the third lens are paired together to form a doublet lens.

13. The imaging lens as claimed in claim 11, wherein a chief ray angle on the image side measured between a chief ray and the optical axis of the imaging lens ranges from −2 degrees to 2 degrees.

14. The imaging lens as claimed in claim 11, wherein at least four lenses of the first lens, the second lens, the third lens, the fourth lens and the fifth lens have a refractive index greater than 1.9.

15. The imaging lens as claimed in claim 11, wherein the first lens, the second lens, the third lens, the fourth lens and the fifth lens respectively have negative, negative, positive, positive and positive refractive powers.

16. The imaging lens as claimed in claim 15, further comprising a sixth lens with a positive refractive power disposed between the first lens and the second lens.

17. The imaging lens as claimed in claim 11, wherein the fourth lens is an aspheric lens.

18. The imaging lens as claimed in claim 11, wherein each of the first lens, the second lens, the third lens, the fourth lens and the fifth lens is a glass lens.

19. The imaging lens as claimed in claim 11, wherein the imaging lens gives the best imaging performance in a wavelength range of 937-943 nm among different wavelengths of near-infrared light.

20. The imaging lens as claimed in claim 11, further comprising:
a cover plate provided with a filter film and disposed on one side of the fifth lens away from the first lens, wherein the filter film is capable of filtering out 99% of light in a wavelength range of 360-830 nm.
